(19) United States
(12) Patent Application Publication
(10) Pub. No.: US 2006/0112318 A1
(43) Pub. Date: May 25, 2006

(54) IMAGE PROCESSING DEVICE

(75) Inventor: Junya Yoda, Osaka (JP)

Correspondence Address: SHINJYU GLOBAL IP COUNSELORS, LLP, 1233 20TH STREET, NW, SUITE 700, WASHINGTON, DC, 20036-2680, US

(73) Assignee: KYOCERA MITA CORPORATION, Osaka (JP)

(21) Appl. No.: 10/904,179

(22) Filed: Oct. 28, 2004

(51) Int. Cl. G06F 11/00

(52) U.S. Cl. 714/57

(57) ABSTRACT

An image processing device is disclosed that includes a main CPU, and a display control CPU that controls the display on a display unit in accordance with commands from the main CPU. When the display control CPU is notified of the occurrence of an abnormality in the main CPU, the display control CPU will acquire notification data concerning the abnormality from a storage unit, and provide a user with the notification data. The user will be notified of the abnormality by means of a display unit that is controlled by the display control CPU, or by a speaker, a warning light, or the like. The user will notice that an abnormality has occurred in the main CPU by means of this notification, will reset the main CPU, and thereby cause the main CPU to recover from the abnormality.

### BACKGROUND OF THE INVENTION

1. Field of the Invention

The present invention relates to an image processing device such as a printer, copying machine, scanner, facsimile, or the like, and more particularly to an image processing device that is controlled by two central processing units (CPUs).

2. Background Information

Image processing devices that employ separate CPUs to respectively control the display on a display unit such as a display screen and control the overall operation of the image processing device are known in the prior art. The display control CPU that controls the display on a display unit is in constant communication with the main CPU that controls the overall operation of the image processing device. This communication allows display data for the display unit to be transmitted from the main CPU to the display control CPU, and the display control CPU will thereby display the transmitted display data on the display unit.

When an abnormality occurs in one of the two CPUs, data transmission from the CPU with the abnormality will be interrupted, and the other CPU will detect that an abnormality has occurred based upon the absence of data transmission.

For example, if the main CPU detects that an abnormality has occurred in the display control CPU, the main CPU will reset the display control CPU in order to recover from the abnormality in the display control CPU. The main CPU can reset the display control CPU because the display control CPU is subordinate to the main CPU (see, for example, Japanese Unexamined Patent Application Publication H08-220946).

However, if an abnormality in the main CPU is detected by the display control CPU (the subordinate CPU), the main CPU cannot be reset by the display control CPU, and thus the main CPU will not recover from the abnormality.

If the main CPU and the display control CPU are not longer able to communicate with each other due to the abnormality in the main CPU, and/or display data is no longer able to be transmitted, the display control CPU will no longer be able to display anything on the display unit, or the last display data transmitted from the main CPU will continue to be displayed on the display unit.

Even if a user notices these types of abnormalities in the display unit, the user cannot recognize that the abnormality is occurring in the main CPU, and thus may operate portions of the image processing device that have nothing to do with the abnormality and cause damage due to that operation. This damage may require the user to call a service representative in order to repair the damage.

When there is an abnormality in the main CPU, the main CPU can often be reset in order to restore the main CPU to normal operation. Despite this, even if the user notices the abnormality on the display unit, the user will not understand the cause of the abnormality on the display unit, and thus the main CPU will not be quickly restored from an abnormal state.

In addition, until the user notices the presence of an abnormality in the display of the display unit, the main CPU will not be restored to a normal state, and thus delays in the processing performed by the image processing device will occur due to the delay in the restoration of the main CPU.

Accordingly, it is an object of the present invention to provide an image processing device that will detect abnormalities in the main CPU, and notify users of the same.

### SUMMARY OF INVENTION

In an image processing device of the present invention, notification data which serves to notify a user of an abnormality in the main CPU is stored in a storage unit that the display control CPU can access. If the display control CPU detects that there is no data transmission from the main CPU, that there is an abnormality in the communications between the main CPU and the display control CPU, or other similar abnormality, the display control CPU will acquire notification data concerning the abnormality from the storage unit and provide the user with the same.

The notification data concerning the abnormality may also include data regarding the steps to be performed by the user in order to recover from the abnormality in the main CPU.

According to the present invention, by providing a user who notices an abnormality on the display unit with notification data concerning the abnormality, the user will understand that the abnormality is caused by an abnormality in the main CPU. In addition, by including in the notification data the steps to be performed by the user in order to recover from the abnormality in the main CPU, the exact steps needed to recover from the abnormality in the main CPU can be performed by the user, even if the user is inexperienced with the operation of the image processing device.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawing which forms a part of this original disclosure:

FIG. 1 is a block diagram showing the overall configuration of an image processing device according to an embodiment of the present invention.

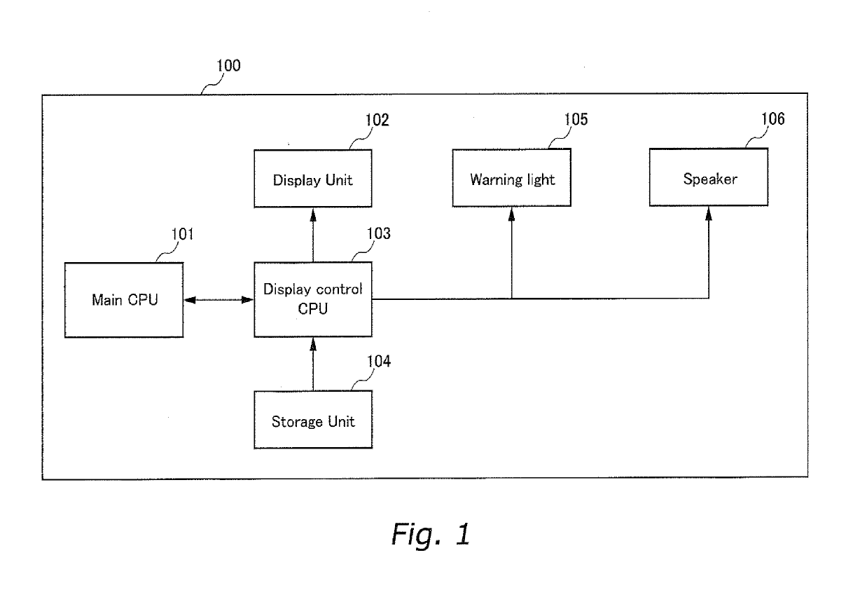

### DETAILED DESCRIPTION

An image processing device 100 of the present invention includes a display control CPU that controls the display of a display unit 102 (such as a liquid crystal screen and the like), and a main CPU 101 that controls, among other things, image processing such as the reading of original documents and the like.

The display control CPU 103 is subordinate (slave) to the main CPU 101. The display control CPU 103 and the main CPU 101 are in continuous communication with each other. Due to this communication, display data that is to be displayed by the display unit 102 is transferred from the main CPU 101 to the display control CPU 103. The display control CPU 103 will display the transferred display data on the display unit 102.

The display data transferred from the main CPU 101 is, for example, print data, original document read data, and the like processed by the main CPU 101, data indicating whether processes performed by the main CPU 101 have been correctly completed, data indicating the number of pages to be printed that was input by a user by means of operation keys arranged on the image processing device, data indicating the printing paper selected by the user by means of the operation keys, and other similar data. The operation keys may be physical keys, or may be keys that are displayed on the display unit 102.

When an abnormality occurs in the main CPU 101 for any reason, such as an overrun or the like, display data will no longer be transferred to the display control CPU 103, the main CPU will no longer transmit responses to queries from the display control CPU 103 back to the display control CPU 103, as well as the occurrence of other similar problems.

In the event that no data communication has occurred from the main CPU 101 within a predetermined period of time (e.g., 1 second), the display control CPU 103 will determine that an abnormality has occurred in the main CPU 101. When the display control CPU 103 determines that an abnormality has occurred, the display control CPU 103 will access a storage unit 104 in which notification data concerning the abnormality is stored and acquire the notification data. The notification data is, for example, data that indicates to a user that an abnormality has occurred in the main CPU 101, data that instructs a user to reset the main CPU 101 by, for example, turning the power to the image processing device 100 off and on, and the like.

The display control CPU 103 will provide the user with the notification data obtained from the storage unit 104. The user can be provided with the acquired notification data by, for example, employing the display device 102, or by employing a warning light 105 or a speaker 106 included in the image processing device 100 to emit a voice, a warning sound, a warning light, or the like.

The user will be instructed by means of the notification data to reset the main CPU 101 when an abnormality has occurred in the main CPU 101. When the user uses the notification data to perform the steps needed to recover from the abnormality in the main CPU 101, such as resetting the main CPU 101 and the like, the user can accurately restore the main CPU 101 to a normal state even if the user is inexperienced in the operation of the image processing device 100.

In addition, by using a voice, a warning sound, or the like to provide the notification data to the user, a user that is not near the image processing device 100 can be informed of the occurrence of an abnormality in the main CPU 101. Thus, the main CPU 101 can be quickly restored to a normal state.

In the aforementioned description, the main CPU 101 was described as a CPU that controls, among other things, image processing such as original document reading. However, the main CPU 101 is not limited to this function so long as the display control CPU 103 is subordinate thereto.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention are provided for illustration only, and not for the purpose of limiting the invention as defined by the appended claims and their equivalents.

What is claimed is:

1. An image processing device, comprising:
a main CPU that communicates with a display control CPU and transmits display data thereto;
a display control CPU that controls a display unit and displays the display data thereon; and
a storage unit that stores notification data concerning an abnormality concerning the main CPU;
wherein if the display control CPU determines that there is an abnormality concerning the main CPU, the display control CPU will acquire the notification data from the storage unit, and will communicate the notification data to a user of the image processing device.

2. The image processing device set forth in claim 1, wherein the notification data instructs the user regarding steps the user is to perform in order to restore the main CPU to a normal state.

3. The image processing device set forth in claim 1, wherein the notification data instructs the user to reset the main CPU by switching a power source of the image processing device off and then on again.

4. The image processing device set forth in claim 1, wherein the display control CPU will determine that an abnormality has occurred in the main CPU when there is no data transmission from the main CPU for a predetermined period of time.

5. The image processing device disclosed in claim 1, wherein the display control CPU will employ the display unit in order to communicate the notification data to the user.

6. The image processing device set forth in claim 1, further comprising a warning light;
wherein the display control CPU will employ the warning light in order to communicate the notification data to the user.

7. The image processing device disclosed in claim 1, further comprising a speaker;
wherein the display control CPU will employ the speaker in order to communicate the notification data to the user.
